(19) United States
(12) Patent Application Publication
(10) Pub. No.: US 2016/0188163 A1
(43) Pub. Date: Jun. 30, 2016

(54) CONTEXT SENSITIVE ICON

(71) Applicant: MAGNET SYSTEMS, INC., Palo Alto, CA (US)

(72) Inventor: Vincent LAU, SUNNYVALE, CA (US)

(21) Appl. No.: 14/849,495

(22) Filed: Sep. 9, 2015

Related U.S. Application Data
(60) Provisional application No. 62/048,125, filed on Sep. 9, 2014.

(51) Int. Cl. G06F 3/0481; H04L 29/08; H04W 4/02

(52) U.S. Cl. CPC G06F 3/04817; H04W 4/02; H04L 67/306; H04L 67/18; H04W 84/12

(57) ABSTRACT

Techniques for providing a context sensitive icon to a mobile device are discussed herein. Some embodiments may provide for a method that includes storing an icon on a mobile device, and changing the icon to modify its association in accordance with a location of the mobile device.

### CROSS REFERENCE TO RELATED APPLICATIONS

This application claims the benefit of U.S. Provisional Patent Application No. 62/048,125, entitled “Context Senstive Icon,” filed Sep. 9, 2014, the content of which is incorporated herein by reference in its entirety.

### FIELD OF THE INVENTION

The present disclosure relates generally to mobile devices, and more particularly to methods and systems for dynamically providing a context sensitive icon for mobile devices.

### BACKGROUND OF THE INVENTION

Mobile devices, such as smartphones, tablet PCs, PDAs have become common tools used daily by consumers. These mobile devices may come pre-installed with manufacturers' mobile operating system and mobile applications such as email, calendar, and contact databases. Some popular mobile applications are Apple iOS, Microsoft Windows Mobile operating systems, Google's Android. Users of these mobile devices may also download other mobile applications using software applications that come with the mobile devices.

Smartphones often include an Internet browser. However, in order to access a website, the user is required to remember the website's URL and enter the URL using the browser. One way to provide a better user experience is to pre-install icons that are frequently used by most users. However, the limited display area of a mobile device makes it inconvenient to locate a desired icon.

### BRIEF SUMMARY OF THE INVENTION

Embodiments of the present invention are related to methods and systems of dynamically providing an icon on the mobile device based on location data of the mobile device. A method may include determining location data by a mobile device, transmitting the location data by the mobile device to a server, generating an icon by the server based at least in part on a portion of the location data, and providing by the server the icon to the mobile device for display. In an embodiment, the location data may include the physical location, environmental data associated with the physical location, and user profile information. A method of dynamically changing an icon for display on a mobile device may include: storing the icon on the mobile device; and changing the icon to modify its association in accordance with a location of the mobile device

A system for dynamically generating a context-based icon may include a mobile device configured to determine location data of a user and transmit the location data to a server. The server is configured to generate an icon and provide the icon to the mobile device for display. A system for dynamically changing an icon presented on a mobile device may include: a server configured to: receive data indicating with a location of the mobile device; and change the icon to modify its association in accordance with the location of the mobile device

The following description, together with the accompanying drawings, will provide a better understanding of the nature and advantages of the claimed invention.

### BRIEF DESCRIPTION OF THE DRAWINGS

FIG. 1 is a simplified schematic diagram of a system of dynamically generating an icon associated with location data according to an embodiment of the present invention;

FIGS. 2A and 2B are exemplary displays of a mobile device according to an embodiment of the present invention;

FIGS. 2C and 2D are exemplary dynamic icons according to an embodiment of the present invention;

FIG. 3 is flow diagram of a process of dynamically generating an icon based on location data according to an embodiment of the present invention;

FIG. 4 is flow diagram of a process of automatically downloading an application according to an embodiment of the present invention and

FIG. 5 is a simplified block diagram of a computer system according to an embodiment of the present invention.

### DETAILED DESCRIPTION OF THE INVENTION

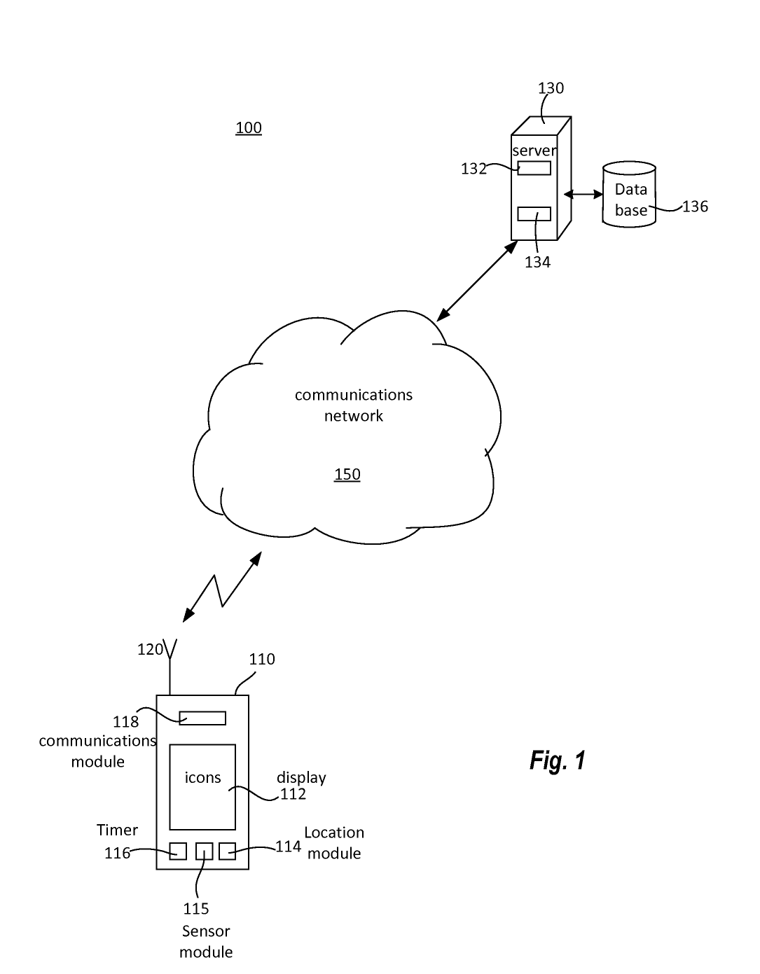

FIG. 1 is a schematic diagram of a system 100 adapted to dynamically update an icon associated with location data according to an embodiment of the present invention. System 100 includes a mobile computing device 110 and a server 130 that communicate with each other through a communications network 150. Although FIG. 1 shows only a single mobile computing device (hereinafter referred to as mobile device), a communications network, and a server, the techniques described herein are not so limited. It is understood that the system 100 can include any number of mobile devices, servers, and communications networks.

Mobile device 110 can be a smart phone, a tablet computer, a portable Internet appliance, a personal digital assistance (PDA), and the like. In some embodiments, mobile device 110 is wearable or portable. In other embodiments, mobile devices 110 may be disposed in a vehicle.

Mobile device 110 may include one or more central processing units (CPUs), one or more peripheral interfaces (e.g., USB), and one or more memory devices (SRAM, EPROM, EEPROM, flash memory devices). Mobile device 110 may run one or more operating systems that are stored in its memory devices.

Mobile device 110 also includes a display 112, a location identification module 114, a data communications module 118, and one or more antennas 120. Location identification module 114 has the capability of determining the device's location and can be a global positioning system device (GPS) device and/or other position determining devices, such as those using Wi-Fi access points, TV signals, cellular grids, etc. Mobile device 110 may further include one or more sensor devices 115 (temperature sensor, air pressure sensor, accelerator sensor, biometrics, QR and/or bar code scanner, digital camera) and a timer 116 configured to keep track of the time.

Data communications module 118 may operate over a GSM network, a GPRS network, an EDGE network, an LTE network, a Wi-Fi network, a WiMax network, and a Bluetooth network. Mobile device 110 communicates with server 130 via communications network 150. Examples of communications network 150 include a local area network (LAN), a metropolitan area network (MAN), a wide area network (WAN), a cellular network, and other data networks forming the Internet.

Server 130 may include a communications module 132, a mobile application configuration module 134, and a database 136. Communications module 132 is configured to connect server 130 with mobile device 110 through communications network 150. Mobile application configuration module 134 is configured to dynamically change a dynamically configurable icon based on the location data received from mobile device 110 as well as the time of day, day of the week, weather conditions, etc. (environmental data). In an embodiment, server 130 may generate (i.e., change a dynamically configurable icon to modify its association and its display properties) in accordance with a location of the mobile device, personal data associated with the user of mobile device 110, environmental data, and the like. The personal data may include the user's age, marital status, race, gender, location of residence, education, hobbies, the mobile device model, etc. The user's personal data is stored in database 136 of server 130. Database 136 may be co-located with server 130 or remote from server 130.

In an embodiment, mobile device 110 may determine a location using location identification module 114 and determine other data associated with the location (e.g., weather conditions, time of the day, day of the week, etc.). Mobile device 110 sends the location and other information data (weather conditions, time) to server 130 via communications network 150. The location and other data associated with the location (referred to as “location data” hereinafter) can be sent to server 130 using any standard wireless transmission or cellular data communications protocols. In an embodiment, the location may be determined by the received signal strength of a local Wi-Fi access point. In another embodiment, the location may be determined by the SSID(s) (service set identifier) of one or more public Wi-Fi access points (hot spots) that represent(s) the location of the access point(s). In yet another embodiment, the location may be determined by the GPS device of location identification module 114.

In an embodiment, in addition to the location data, other data such as the time of the day (obtained by timer 116), weather conditions (obtained by sensor 115), and the like. Mobile device 110 sends such data to server 130 using data communications module 118.

Server 130 receives the location data and generates (hereinafter, the term “generate an icon” is alternatively used to refer to as dynamically change a configurable icon) in accordance with the location data and/or other data described above. The generated (configured or changed) icon may be associated with the name and/or logo of a merchant, a store, a business corporation, an entertainment center (theater, cinema, nightclub), referred to herein as an entity. In addition to changing the icon, a link to the entity's webpage may also be presented to the user for access. In an exemplary embodiment, if server 130 determines that mobile device 110 is at a nearly equal distance from two or more entities, server 130 may change the icon based on, for example, the personal data of the user and the data associated with the location. For example, if the mobile device is at an equal distance from a fast food restaurant, an Indian restaurant, and a Chinese restaurant, server 130 may dynamically change a configurable icon based on the user's personal data (race, age) to select from these restaurants. In another example, the icon may be changed to represent a women's apparel store if the server determines the user is a female and the time of the day is either in the morning, afternoon, or other convenient times. In yet another example, data associated with the location may be a weather condition. For example, if server 130 determines that the weather in that location is hot, it may change the dynamically configurable icon to be associated with an ice cream parlor in the vicinity. If the weather is cold, the changed icon may be associated with a café nearby. Likewise, for example, if it is raining, the server may dynamically change the icon to be associated with an entertainment center in the vicinity of the location. In other words, in accordance with the present invention, server 130 may dynamically (i.e., in real time) change the icon by taking into account context other than the location. Other context may be the time of the day, weather conditions, gender, age, interests, hobbies of the user, and the model of the mobile device.

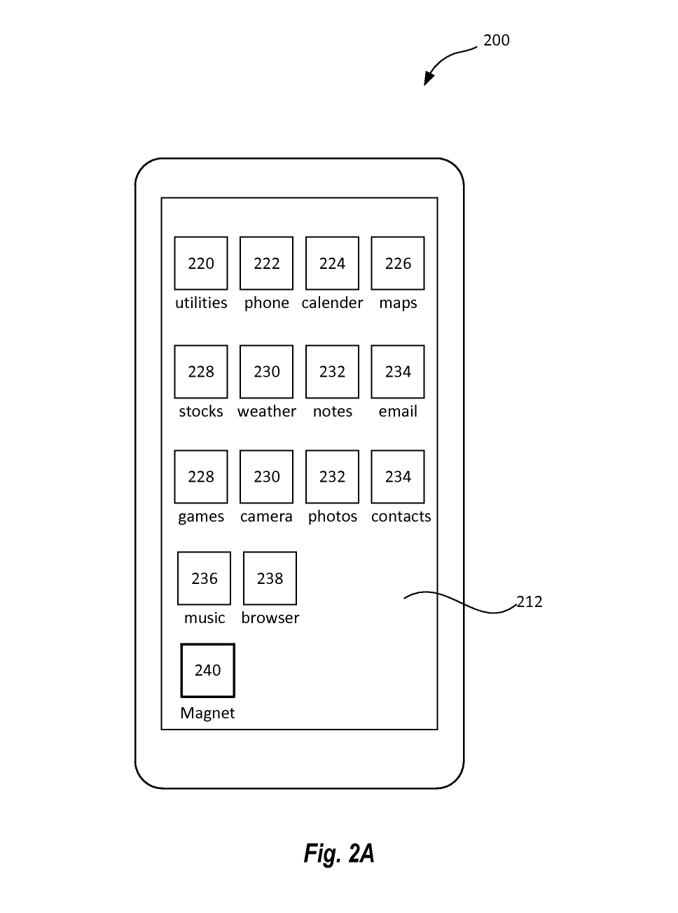

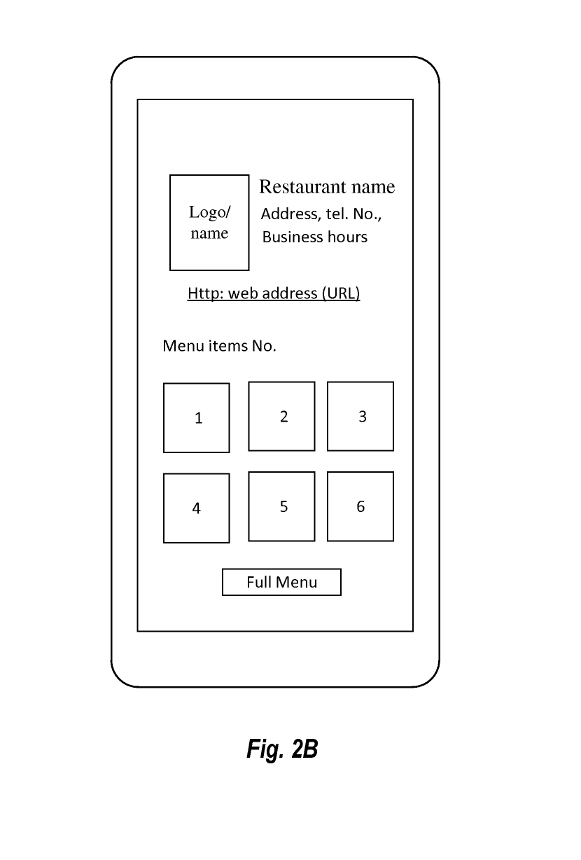

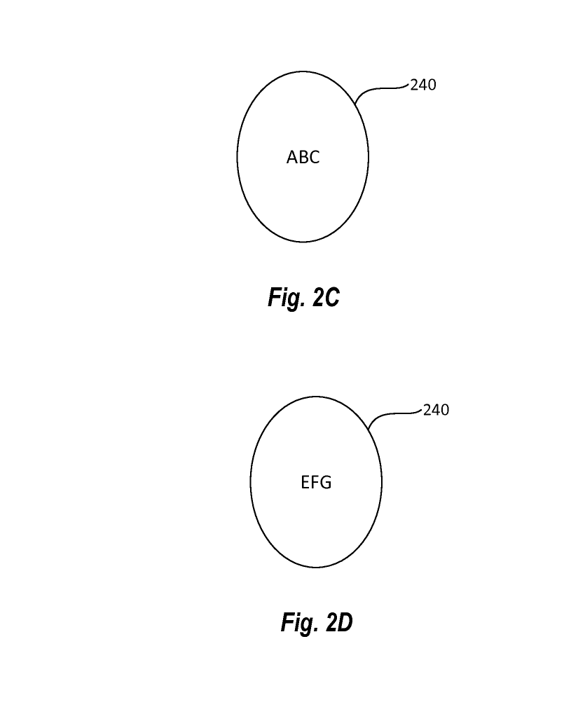

FIG. 2A is an exemplary display screen 212 of a mobile device 200 according to an embodiment of the present invention. Display screen 212, as shown, may include multiple icons such as utilities icon 220, phone icon 222, calendar icon 224, Maps icon 226, stocks icon 228, weather icon 230, Notes icon 232, email icon 234, games icon 236, camera icon 238, photos icon 240, contacts icon 242, music icon 244, browser icon 246, and the like. Icons 220-238 are assumed to be static and represent applications that may be pre-installed by a manufacturer or downloaded by the user. Once they are installed in the mobile device, static icons will run the same software applications when activated by the user independently of the time and location of the user. As shown, icons 220-238 often occupy a significant portion of the display screen 212. Any additional icons are accessed by scrolling to a different page on the display.

As discussed above, if a user of a mobile device wants to access a website that is not available in the URL bookmarks, she has to remember the URL of that website, start the Internet browser, and enter the URL, which is a time consuming process. The user experience can be improved by pre-installing most frequently accessed applications as icons in the mobile device. For example, the user may create more pages for storing icons associated with favorite restaurants, entertainment, sports equipment, airlines, etc. This requires the user to scroll several display pages to locate the icon associated with an entity. This approach is however cumbersome and consumes memory space. The user may also add the new URL to the URL bookmarks for future use. This approach requires that the user manually give the new URL a name and categorize the URL into an associated bookmark for future retrieval. The approach is cumbersome and limits the effectiveness of search for Internet-based information and content.

Embodiments of the present invention provide a context-aware icon to the problems described above. In an embodiment, a dynamically configurable icon 240 is installed or downloaded on the display screen 212, as shown in FIG. 2A. Icon 240 is a place holder and may be changed (updated) in real-time based on contexts and factors, as described above. Such context may include the location of the mobile device, and other data such as environmental conditions, the user's profile information, and the like. The mobile device is equipped with a location identification module configured to determine its location in real time and communicate the determined location to the server. For example, if the mobile device is detected as being in the vicinity of a restaurant, icon 240 is changed to display the logo/name of the restaurant ABC (if available) and to be associated with restaurant ABC, as shown in FIG. 2C. In one embodiment, when the user selects the ABC icon, an application is run to display the name of the restaurant including its address, telephone number, the business hours, and/or the web address URL. The display may also include restaurant ABC's food menu and the corresponding pictures, as shown in FIG. 2B. The display may include a “Full Menu” short-cut key, which when tapped directs the user to a new home page of the restaurant. The new home page may include a list of appetizers, salads, entrees, deserts, beverages, lunch specials, soup du jour, chef's recommendations, and the like. It will be appreciated that the example shown in FIGS. 2A-D is illustrative and not limiting. For example, if the server determines that the mobile device is in the vicinity of a women's apparel store EFG and the user is a female, the server may dynamically change configurable icon 240 so that icon 240 displays apparel store EFG's logo/name and is associated with store EFG, as shown in FIG. 2D. When tapped, an application associated with the logo may be executed to show EFG's clothing selection on a new home page.

In an embodiment, server 130 may collect entity information on its own and store the collected information in database 136. Collected information data will be processed by a user data analysis engine to determine the user's habits, interests, and/or online behavior. In another embodiment, companies that are interested in using services of server 130 may provide information to server 130. In yet another embodiment, server 130 may send out invitation to companies soliciting their business. Server 130 may have a website that contains application forms that entities can fill out online. Server 130 may offer its service for a fee or at no charge to subscribers or entities. In an embodiment, server 130 receives location data from mobile device 110, retrieves from database 136 information of the entity associated with the location data, and dynamically changes icon 240 in part in accordance with the location data. By dynamically changing the icon in accordance with the sensed data (e.g., its location, environmental conditions, time of the day, etc.), a better user experience can be achieved through savings of display area, memory space and processing power of the mobile device.

In some embodiments, mobile application configuration module 134 disposed in server 130 may change the icon according to the physical size of icons 220-238 shown on display screen 112. In other embodiments, the dynamic icon may have a different size and display a logo associated with server 130 (e.g., “Magnet” as shown FIG. 2A). In one embodiment, the dynamic icon is provided by server 130 based on the mobile device model to fit the place holder icon 240. In an embodiment, the provided icon may include the logo and text such as the entity name associated with the logo. In another embodiment, if server 130 determines that one or more entities are in the vicinity of the mobile device, it may select the entity based on the user profile information stored in the database 136 and/or the time of the day. In yet another embodiment, server 130 may randomly select an entity from among a multitude of entities based only on the location of the mobile device. Mobile application configuration module 134 of server 130 configures the icon based on the size of the place holder icon 240 and provides the generated icon to the mobile device.

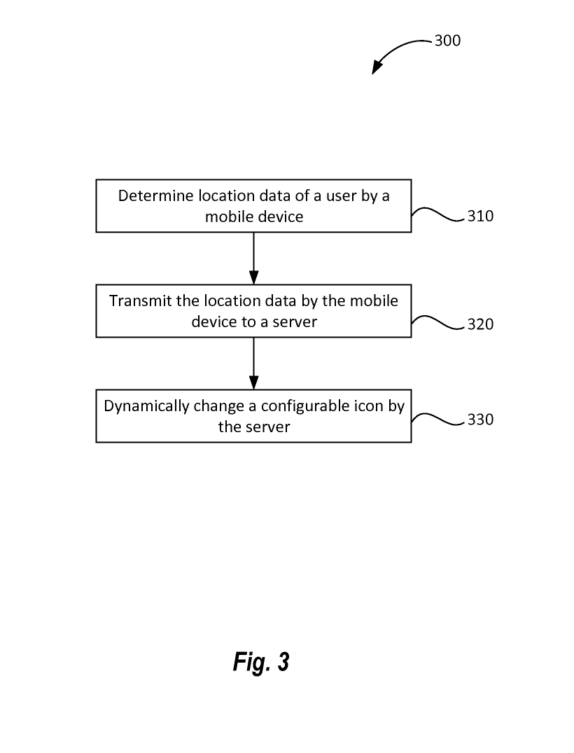

FIG. 3 is a flow diagram of a method 300 for dynamically changing an icon using system 100 of FIG. 1. Method 300 includes determining location data including a location and data associated with the location by a mobile device (310). The mobile device transmits the location data to a server (320). The server receives the location data and dynamically changes a configurable icon based at least in part on a portion of the received location data (330). The mobile device displays the dynamic icon on the display screen for viewing by the user. The dynamic icon is configured to interact with an operating system of the mobile device. If the user taps on the dynamic icon, this action will cause the mobile device to launch an application associated with the dynamic icon. The application may provide a link to the website associated with the icon (e.g., a logo/name of an entity) or present a page content of the website of the entity. If the application has not been installed in the mobile device, the action will cause the mobile device to automatically download the application from the server without the user's involvement. In other words, the user is not required to use a web browser or app store to access and download the application. It is performed automatically once the dynamically configurable icon is clicked on by the user.

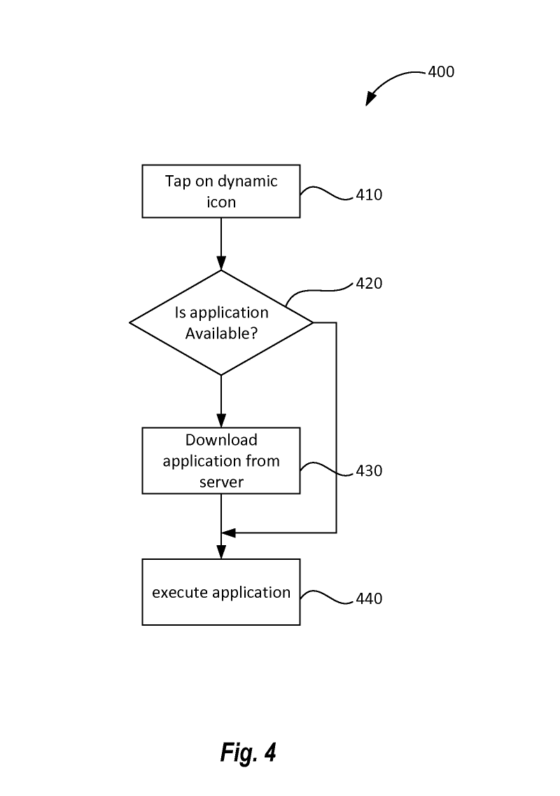

FIG. 4 is a flow chart of a method 400 of automatically download an application according to an embodiment of the present invention. At 410, a user taps on the dynamic icon displayed on the display panel of a mobile device. The mobile device determines whether or not an application associated with the tapped icon is available. If the application is available, then the mobile device launches the application at 430. If the application is not available, the mobile device will download the application from the server without any involvement from the user at 440, and launches the application at 430.

In some embodiments, mobile device 110 transmits its location and other associated data (time of the day, weather conditions, activities of the user) to server 130 at a regular or irregular time interval. For example, if the location of the mobile device does not change (the user is at a restaurant or at a theater), then the mobile device may not transmits any data to the server until there is a change in the user' location. If the location has changed rapidly, then the mobile device may transmit the change of location at a shorter time interval so that the server can dynamically update the icon based on the newly received location data of the mobile device.

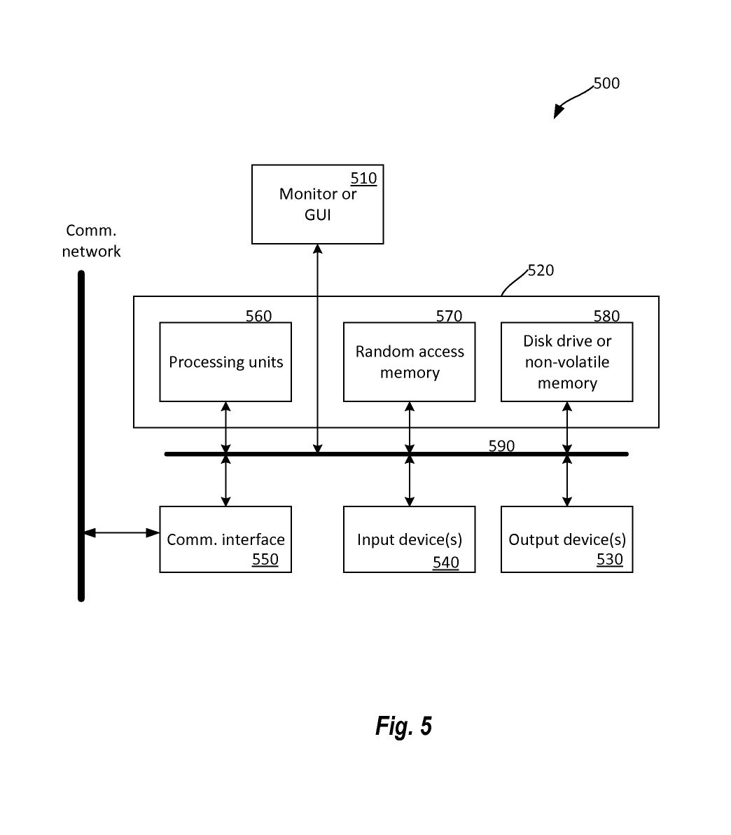

FIG. 5 is a simplified block diagram of a computer system that may incorporate embodiments of the present invention. FIG. 5 is merely illustrative of an embodiment incorporating the present invention and does not limit the scope of the invention as recited in the claims. One of ordinary skill in the art would recognize other variations, modifications, and alternatives.

In one embodiment, computer system 500 typically includes a monitor 510, a computer 520, user output devices 530, user input devices 540, communications interface 550, and the like. Computer system 500 may be a server or a smart phone, tablet-computing device, and the like, such that the boundary of computer 520 may enclose monitor or graphical user interface (GUI) 510, user output devices 530, user input devices 540, and/or communications interface 550.

As shown in FIG. 5, computer 520 may include one or more processing units 560 that communicate with a number of peripheral devices via a bus subsystem 590. These peripheral devices may include user output devices 530, user input devices 540, communications interface 550, and a storage subsystem, such as random access memory (RAM) 570 and disk drive or non-volatile memory 580.

User input devices 530 include all possible types of devices and mechanisms for inputting information to computer system 520. These may include a keyboard, a keypad, a touch screen incorporated into the display, audio input devices such as voice recognition systems, microphones, and other types of input devices. In various embodiments, user input devices 530 are typically embodied as a computer mouse, a trackball, a track pad, a joystick, wireless remote, drawing tablet, voice command system, eye tracking system, gesture recognition system, and the like. User input devices 530 typically allow a user to select objects, icons, text and the like that appear on the monitor or graphical user interface 310 via a command such as a click of an icon, touch of the display screen, or the like.

User output devices 540 include all possible types of devices and mechanisms for outputting information from computer 520. These may include a display (e.g., monitor or graphical user interface 510), non-visual displays such as audio output devices, and the like.

Communications interface 550 provides an interface to other communication networks and devices. Communications interface 550 may serve as an interface for receiving data from and transmitting data to other systems. Embodiments of communications interface 550 typically include an Ethernet card, a modem (telephone, satellite, cable, ISDN), (asynchronous) digital subscriber line (DSL) unit, FireWire interface, USB interface, and the like. For example, communications interface 550 may be coupled to a computer network, to a FireWire bus, or the like. In other embodiments, communications interfaces 550 may be physically integrated on the motherboard of computer 520, and may be a software program, such as a software-defined DSL, or the like. Embodiments of communications interface 550 may also include a wireless radio transceiver using radio transmission protocols such as Bluetooth®, WiFi®, cellular, and the like.

RAM 570 and disk drive or non-volatile memory 380 are examples of tangible media configured to store data such as embodiments of the present invention, including executable computer code, human readable code, or the like. Other types of tangible media include floppy disks, removable hard disks, optical storage media such as CD-ROMS, DVDs and bar codes, semiconductor memories such as flash memories, read-only-memories (ROM), battery-backed volatile memories, networked storage devices, and the like. RAM 570 and disk drive or non-volatile memory 580 may be configured to store the basic programming and data constructs that provide the functionality of the present invention.

Software code modules and instructions that provide the functionality of the present invention may be stored in RAM 570 and disk drive or non-volatile memory 380. These software modules may be executed by processing units) 560. RAM 570 and disk drive or non-volatile memory 580 may also provide a repository for storing data used in accordance with the present invention.

RAM 570 and disk drive or non-volatile memory 580 may include a number of memories including a main random access memory (RAM) for storage of instructions and data during program execution and a read only memory (ROM) in which fixed instructions are stored. RAM 370 and disk drive or non-volatile memory 580 may include a file storage subsystem providing persistent (non-volatile) storage for program and data files. RAM 570 and disk drive or non-volatile memory 580 may also include removable storage systems, such as removable flash memory.

Bus subsystem 590 provides a mechanism for letting the various components and subsystems of computer 520 communicate with each other as intended. Although bus subsystem 590 is shown schematically as a single bus, alternative embodiments of the bus subsystem may utilize multiple busses or switches.

Various embodiments of the present invention can be implemented in the form of logic in software or hardware or a combination of both. The logic may be stored in a computer readable or machine-readable non-transitory storage medium as a set of instructions adapted to direct a processor of a computer system to perform a set of steps disclosed in embodiments of the present invention. The logic may form part of a computer program product adapted to direct an information-processing device to perform a set of steps disclosed in embodiments of the present invention. Based on the disclosure and teachings provided herein, a person of ordinary skill in the art will appreciate other ways and/or methods to implement the present invention.

In summary, embodiments of the present invention provide a method and system of dynamically (just-in-time) generating an icon based on the location and data associated with the location of the mobile device and providing the icon to the mobile device for display. The displayed icon may include a logo and additional information associated with a third party. The mobile device transmits data associated with a location change to the server. The server will generated a new icon based at least on a portion of the data of the location change of the mobile device. That is, the server pushes information in the form of an icon to the user. If the icon is activated (i.e., when the user clicked on it), an application will be launched if the application has been installed in the mobile device. The application may allow the user to access the party-party website and display a page of content associated with the website. If the application has not been installed or available in the mobile device, the action (clicking of the icon) will automatically download the application from the server to the mobile device.

Although the present invention has been described with reference to the above embodiments, it is apparent to one of ordinary skill in the art that modifications to the described embodiments may be made without departing from the scope of the invention. Accordingly, the scope of the invention will be defined by the appended claims and not by the above detailed descriptions.

What is claimed is:

1. A method of dynamically changing an icon for display on a mobile device, the method comprising:
storing the icon on the mobile device; and
changing the icon to modify its association in accordance with a location of the mobile device.

2. The method of claim 1, wherein the location is determined based on a received signal strength of a radio frequency signal having a predetermined frequency.

3. The method of claim 2, wherein the radio frequency signal is one of a television broadcast signal, a Wi-Fi signal, or a WiMax signal.

4. The method of claim 2, wherein the location is determined based on an SSID of a WiFi access point.

5. The method of claim 2, wherein the location is determined based on position data obtained by a GPS device.

6. The method of claim 2, wherein the location comprises an environmental condition.

7. The method of claim 1, further comprising:
launching an application associated with the icon by the mobile device when the icon is clicked on by a user.

8. The method of claim 7, wherein launching the application comprises:
determining, by the mobile device, whether the application is available in the mobile device; and
in the event that the application is available, executing the application.

9. The method of claim 7, wherein launching the application comprises:
determining, by the mobile device, whether the application is available in the mobile device; and
in the event that the application is not available, automatically downloading the application by the mobile device.

10. The method of claim 1, further comprising:
determining a location change by the mobile device;
transmitting data associated with the location change to the server by the mobile device;
generating a second icon associated with the location change by the server;
providing, by the server, the second icon to the mobile device; and
displaying the second icon by the mobile device.

11. The method of claim 1, wherein changing the icon comprises:
modifying its association in accordance with a profile of a user.

12. The method of claim 1, wherein changing the icon comprises:
modifying its association in accordance with environmental data.

13. A system for dynamically changing an icon presented on a mobile device, the system comprising:
a server configured to:
receive data indicating with a location of the mobile device; and
change the icon to modify its association in accordance with the location of the mobile device.

14. The system of claim 13, wherein the icon is configured to launch an application when activated by the user if the application has been installed in the mobile device.

15. The system of claim 13, wherein the icon is configured to automatically download the application when the application has not been installed in the mobile device.

16. The system of claim 13, wherein the icon comprises a logo associated with a third party, and the application accesses a website of the third party and displays a page of content associated with the website.

17. The system of claim 13, further comprising a database including user profile information and information data associated with an entity.

18. The system of claim 17, wherein the data associated with the entity is provided by the entity to the server.

19. The system of claim 13, wherein the server is further configured to change the icon to modify its association in accordance with a user profile.

20. The system of claim 13, wherein the server is further configured to change the icon to modify its association in accordance with environmental data.
